(19) United States
(12) Patent Application Publication
(10) Pub. No.: US 2023/0027459 A1
(43) Pub. Date: Jan. 26, 2023

(54) MICRO-BUBBLE SPRAY HEAD AND WASHING APPARATUS HAVING SAME

(71) Applicants: QINGDAO HAIER WASHING MACHINE CO., LTD., Qingdao, Shandong (CN); Haier Smart Home Co., Ltd., Qingdao,Shandong (CN)

(72) Inventors: Zhiqiang ZHAO, Qingdao (CN); Sheng XU, Qingdao (CN)

(73) Assignees: QINGDAO HAIER WASHING MACHINE CO., LTD., Qingdao, Shandong (CN); Haier Smart Home Co., Ltd., Qingdao, Shandong (CN)

(21) Appl. No.: 17/777,908

(22) PCT Filed: Nov. 20, 2020
(86) PCT No.: PCT/CN2020/130508

§ 371 Date: May 18, 2022

(30) Foreign Application Priority Data
Nov. 22, 2019 (CN) 201911157487.3
Nov. 22, 2019 (CN) 201911157505.8
Nov. 26, 2019 (CN) 201911177037.0

(51) Int. Cl. B01F 23/2373; B01F 23/232; B01F 25/312; B05B 1/34; D06F 39/08

(52) U.S. Cl. CPC B01F 23/2373; B01F 23/232; B01F 25/3121; B01F 25/31242; B05B 1/34; D06F 39/088

(57) ABSTRACT

A micro-bubble spray head and a washing apparatus. The micro-bubble spray head includes an integrated spray tube and a micro-bubble bubbler fixed on the outlet end of the integrated spray tube; a throttling passage portion is formed in the integrated spray tube; a plurality of throttling passages parallel to each other and having a uniform cross section are formed in the throttling passage portion along a water stream direction, so that a plurality of water streams can be formed in the plurality of throttling passages parallel to each other and having the uniform cross section and are sprayed out from the outlets of the plurality of throttling passages parallel to each other and having the uniform cross section in an expansion manner, so as to form negative pressure near the outlets; a plurality of air inlets serving as air inlet passages are further provided on the integrated spray tube.

### CROSS-REFERENCE TO RELATED APPLICATIONS

The present application claims priority from the following prior applications:

Chinese patent application for invention with the application No. “201911157505.8” filed on Nov. 22, 2019;

Chinese patent application for invention with the application No. “201911157487.3” filed on Nov. 22, 2019; and

Chinese patent application for invention with the application No. “201911177037.0” filed on Nov. 26, 2019. The contents of these applications are incorporated into the present application by reference in their entirety.

### FIELD

The present disclosure relates to a micro-bubble generation device, and specifically relate to a micro-bubble spray head and a washing apparatus having the micro-bubble spray head.

### BACKGROUND

Micro-bubbles usually refer to tiny bubbles with a diameter below 50 micrometers (μm) during bubbles generation. Micro-bubbles may also be called micro-/nano-bubbles, micron-bubbles or nano-bubbles depending on their ranges of diameter. Due to their low buoyancy in a liquid, micro-bubbles stay for a longer time in the liquid. Furthermore, the micro-bubbles will shrink in the liquid until they finally break up, generating smaller nano-bubbles. In this process, a rising speed of the bubbles becomes slow since the bubbles become smaller, thus resulting in a high melting efficiency. When the micro-bubbles break up, high-pressure and high-temperature heat is locally generated, thereby destroying foreign objects such as organic matters floating in the liquid or adhering to objects. In addition, the shrinkage process of micro-bubbles is also accompanied by an increase in negative charges. A peak state of negative charges usually occurs when the diameter of the micro-bubbles is 1-30 microns, so it is easy for them to adsorb positively charged foreign matters floating in the liquid. The result is that the foreign matters are adsorbed by the micro-bubbles after they are destroyed due to the breaking up of the micro-bubbles, and then slowly float to a surface of the liquid. These properties enable the micro-bubbles to have extremely strong cleaning and purifying abilities. At present, micro-bubbles have been widely used in washing apparatuses such as clothing washing machines.

In order to produce micro-bubbles, micro-bubble generation devices of different structures have been developed. For example, Chinese patent application for invention (CN107321204A) discloses a micro-bubble generator. The micro-bubble generator includes a shell with two open ends; a water inflow pipe is connected to a first end of the shell, and a vortex column, a vortex column shell, a gas-liquid mixing pipe and a hole mesh positioned at a second end of the shell are arranged in sequence inside the shell in a water flow direction. The gas-liquid mixing pipe is sequentially formed with an accommodation cavity, an air flow part, an acceleration part and a circulation part that communicate with each other from head to tail. The vortex column shell and the vortex column located in the vortex column shell are positioned in the accommodation cavity; an air inlet is provided on a pipe wall of the air flow part; an inner wall of the air flow part protrudes toward the direction of the accommodation cavity, forming a funnel-shaped protruding part; a slit is formed between a large mouth end of the funnel-shaped protruding part and the conical vortex column shell so that the air entering from the air inlet can enter the air flow part; an inner diameter of the acceleration part gradually increases toward the direction of the tail. A water flow flows through the vortex column to form a high-speed rotating water flow inside the vortex column shell, and the high-speed rotating water flow flows out from an outlet of the vortex column shell and then enters a funnel-shaped space enclosed by the protruding part. Air is sucked in from the air inlet by a negative pressure formed around the water flow and mixed with the water flow before entering the acceleration part. Because of a conical surface of the vortex column shell and a pressure difference formed due to the inner diameter of the acceleration part gradually increasing toward the direction of the tail, the water flow mixed with a large amount of air (forming bubble water) flows in an accelerated state, and the bubble water flows to the hole mesh through the circulation part. The bubble water is cut and mixed by fine holes in the hole mesh to produce micro-bubble water containing a large number of micro-bubbles.

Chinese patent application for invention (CN107583480A) also discloses a micro-bubble generator. The micro-bubble generator includes a shell with two open ends; a water inflow pipe is connected to a first end of the shell, and a pressurizing pipe, a bubble generation pipe and a hole mesh positioned at a second end of the shell are arranged in sequence inside the shell in a water flow direction. From a first end to a second end, the bubble generation pipe is sequentially formed with an accommodation cavity, a gas-liquid mixing part, and an expansion and guide part. The pressurizing pipe is received in the accommodation cavity, and the pressurizing pipe has a conical end facing the accommodation cavity; in the gas-liquid mixing part, a conical gas-liquid mixing space whose size gradually decreases in a direction from the first end to the second end is formed; and an expansion and guide space whose size increases in the direction from the first end to the second end is formed in the expansion and guide part. An air inflow passage is formed on a pipe wall of the bubble generation pipe, a gap is formed between an inner wall of the gas-liquid mixing part and an outer wall of the pressurizing pipe so as to communicate with the air inflow passage on the pipe wall of the bubble generation pipe, and a water outlet of the pressurizing pipe is arranged in a water inlet of the gas-liquid mixing part. The water flow flows through the pressurizing pipe and is pressurized to form a high-speed water flow. The high-speed water flow flows out from the water outlet of the pressurizing pipe and then enters the gas-liquid mixing cavity to form a negative pressure in the gas-liquid mixing cavity. The negative pressure sucks a large amount of air into the water flow through the air inflow passage and enables the air and water to mix with each other to form bubble water. The bubble water flows from the expansion and guide part to the hole mesh, and the bubble water is mixed and cut by the fine holes of the hole mesh to form micro-bubble water.

The above two kinds of micro-bubble generators each have at least five independent components: a shell, a water inflow pipe, a vortex column and a vortex column shell or a pressurizing pipe, a gas-liquid mixing pipe or a bubble generation pipe, and a hole mesh. These components all need to be designed with specific mating or connection structures so that all these components can be assembled together and the assembled micro-bubble generator can work reliably. Therefore, the components and structures of such micro-bubble generators are relatively complicated, and the manufacturing cost is also high.

Accordingly, there is a need in the art for a new technical solution to solve the above problem.

### SUMMARY

In a first embodiment, in order to solve the above problem in the prior art, that is, to solve the technical problem that existing micro-bubble generators have a complicated structure and the manufacturing cost is high, the present disclosure provides a micro-bubble spray head, which includes a one-piece spray pipe and a micro-bubble bubbler fixed at an outlet end of the one-piece spray pipe; a throttling passage part is provided in the one-piece spray pipe, and the throttling passage part is formed therein with a plurality of equal-section throttling passages parallel to each other in a water flow direction, so that multiple streams of water flows can be formed in the plurality of equal-section throttling passages and sprayed in an expanded state from outlets of the plurality of equal-section throttling passages to generate a negative pressure near the outlets; an air inflow passage is also provided on the one-piece spray pipe, and the air inflow passage is positioned close to the outlets so that air can be sucked in from the air inflow passage under the action of the negative pressure and mix with the multiple streams of water flows to generate bubble water, which becomes micro-bubble water under the action of the micro-bubble bubbler.

In a preferred technical solution of the above micro-bubble spray head, the throttling passage part is integrally formed with the one-piece spray pipe.

In a preferred technical solution of the above micro-bubble spray head, the throttling passage part is formed independently from the one-piece spray pipe.

In a preferred technical solution of the above micro-bubble spray head, the plurality of equal-section throttling passages are evenly distributed in an annular form around a center of the one-piece spray pipe.

In a preferred technical solution of the above micro-bubble spray head, the air inflow passage is a plurality of air inflow holes arranged on a pipe wall of the one-piece spray pipe, or the air inflow passage is formed between the outlet end and the micro-bubble bubbler.

In a preferred technical solution of the above micro-bubble spray head, the micro-bubble bubbler includes a hole mesh and a hole mesh skeleton, and the hole mesh is attached to the outlet end of the one-piece spray pipe through the hole mesh skeleton.

In a preferred technical solution of the above micro-bubble spray head, the hole mesh skeleton is provided with at least one overflow hole, and the at least one overflow hole is positioned close to the hole mesh.

In a preferred technical solution of the above micro-bubble spray head, the micro-bubble bubbler also includes a pressure ring, and the pressure ring is configured to be positioned between the hole mesh skeleton and the outlet end of the one-piece spray pipe to fix the hole mesh.

In a preferred technical solution of the above micro-bubble spray head, a plurality of pressure ring holes are provided on the pressure ring in a circumferential direction.

It can be understood by those skilled in the art that in the technical solutions of the present disclosure, the micro-bubble spray head includes a one-piece spray pipe and a micro-bubble bubbler installed at the outlet end of the one-piece spray pipe. A throttling passage part is provided in the one-piece spray pipe, and the throttling passage part is formed therein with a plurality of equal-section throttling passages parallel to each other in a water flow direction. A water flow entering the one-piece spray pipe is divided into multiple streams of water flows after entering the plurality of equal-section throttling passages, and the multiple streams of water flows are then sprayed in an expanded state from the outlets of the plurality of equal-section throttling passages and generate a negative pressure near the outlets. An air inflow passage is also provided on the one-piece spray pipe, and the air inflow passage is positioned close to the outlets of the plurality of equal-section throttling passages so that under the action of the negative pressure, a large amount of air is sucked into the one-piece spray pipe from the outside through the air inflow passage and mixes with the multiple streams of water flows to produce bubble water containing a large number of bubbles. The bubble water then flows through the micro-bubble bubbler located at the outlet end of the one-piece spray pipe so as to be cut and mixed by the micro-bubble bubbler, thereby producing micro-bubble water containing a large number of micro-bubbles. In the technical solutions of the micro-bubble spray head of the present disclosure, the function of producing micro-bubble water is realized by the throttling passage part having a plurality of equal-section throttling passages designed in the one-piece spray pipe, the air inflow passage on the one-piece spray pipe, and the micro-bubble bubbler fixed at the outlet end of the one-piece spray pipe. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Preferably, the plurality of equal-section throttling passages are evenly distributed in an annular form around the center of the one-piece spray pipe. This even annular distribution facilitates more air to be sucked in to perform gas-liquid premixing with the multiple streams of water flows.

Preferably, the bubbler includes a hole mesh and a hole mesh skeleton, and the hole mesh is attached to the outlet end of the one-piece spray pipe through the hole mesh skeleton. The hole mesh skeleton is provided with at least one overflow hole positioned close to the hole mesh. These overflow holes can prevent excess water from flooding the air inflow hole or other air inflow passages, thereby preventing a situation in which the micro-bubble water cannot be produced since the air cannot be sucked into the one-piece spray pipe due to blockage of the air inflow hole or other air inflow passages.

Preferably, the micro-bubble bubbler also includes a pressure ring, which is configured to be positioned between the hole mesh skeleton and the outlet end of the one-piece spray pipe to fix the hole mesh, and a plurality of pressure ring holes are provided on the pressure ring in a circumferential direction. On one hand, when a flow rate of sprayed water is not large, air can be sucked in through these pressure ring holes and mix with water to generate micro-bubble water; on the other hand, when the flow rate of sprayed water is too large, part of the water can overflow from these pressure ring holes. The overflow can not only help clean a surface of the hole mesh and take away dirt so as to improve a service life of the hole mesh, but also can prevent a phenomenon in which the micro-bubble water cannot be produced since the air cannot be sucked in due to blockage of the air inflow passage by excess water.

In a second embodiment, in order to solve the above problem in the prior art, that is, to solve the technical problem that existing micro-bubble generators have a complicated structure and the manufacturing cost is high, the present disclosure provides a micro-bubble spray head, which includes a one-piece spray pipe and a micro-bubble bubbler fixed at an outlet end of the one-piece spray pipe; a varying-diameter passage part is provided in the one-piece spray pipe, and the varying-diameter passage part is formed therein with a plurality of varying-diameter passages parallel to each other in a water flow direction; each of the varying-diameter passages includes a diameter-decreased conical passage and a diameter-increased conical passage in sequence in the water flow direction, and a water flow that can be pressurized by the diameter-decreased conical passage can be expanded in the diameter-increased conical passage to generate a negative pressure near an outlet of the varying-diameter passage; an air inflow passage is also provided on the one-piece spray pipe, and the air inflow passage is positioned close to the outlet so that air can be sucked in from the air inflow passage under the action of the negative pressure and mix with multiple streams of water flows from the plurality of varying-diameter passages to generate bubble water, which becomes micro-bubble water under the action of the micro-bubble bubbler.

In a preferred technical solution of the above micro-bubble spray head, the varying-diameter passage part is integrally formed with the one-piece spray pipe.

In a preferred technical solution of the above micro-bubble spray head, the varying-diameter passage part is formed independently from the one-piece spray pipe.

In a preferred technical solution of the above micro-bubble spray head, the plurality of varying-diameter passages are evenly distributed in an annular form around a center of the one-piece spray pipe.

In a preferred technical solution of the above micro-bubble spray head, the air inflow passage is a plurality of air inflow holes arranged on a pipe wall of the one-piece spray pipe, or the air inflow passage is formed between the outlet end and the micro-bubble bubbler.

In a preferred technical solution of the above micro-bubble spray head, the micro-bubble bubbler includes a hole mesh and a hole mesh skeleton, and the hole mesh is attached to the outlet end of the one-piece spray pipe through the hole mesh skeleton.

In a preferred technical solution of the above micro-bubble spray head, the hole mesh skeleton is provided with at least one overflow hole, and the at least one overflow hole is positioned close to the hole mesh.

In a preferred technical solution of the above micro-bubble spray head, the micro-bubble bubbler also includes a pressure ring, and the pressure ring is configured to be positioned between the hole mesh skeleton and the outlet end of the one-piece spray pipe to fix the hole mesh.

In a preferred technical solution of the above micro-bubble spray head, a plurality of pressure ring holes are provided on the pressure ring in a circumferential direction.

It can be understood by those skilled in the art that in the technical solutions of the present disclosure, the micro-bubble spray head includes a one-piece spray pipe and a micro-bubble bubbler installed at the outlet end of the one-piece spray pipe. A varying-diameter passage part is provided in the one-piece spray pipe, and the varying-diameter passage part is formed therein with a plurality of varying-diameter passages parallel to each other in a water flow direction. Each of the varying-diameter passages includes a diameter-decreased conical passage and a diameter-increased conical passage in sequence in the water flow direction. The water flow in the diameter-decreased conical passage can be pressurized (also accelerated), and the pressurized water flow enters the diameter-increased conical passage and can be rapidly expanded, thereby generating a negative pressure near the outlet of the varying-diameter passage. Thus, these varying-diameter passages constitute multiple Venturi structures. An air inflow passage is also provided on the one-piece spray pipe, and the air inflow passage is positioned close to the outlets of the varying-diameter passages so that under the action of the negative pressure, a large amount of air is sucked into the one-piece spray pipe from the outside through the air inflow passage and mixes with multiple streams of water flows from the plurality of varying-diameter passages to produce bubble water containing a large number of bubbles. The bubble water then flows through the micro-bubble bubbler located at the outlet end of the one-piece spray pipe so as to be cut and mixed by the micro-bubble bubbler, thereby producing micro-bubble water containing a large number of micro-bubbles. In the technical solutions of the micro-bubble spray head of the present disclosure, the function of producing micro-bubble water is realized by the varying-diameter passage part having a plurality of varying-diameter passages designed in the one-piece spray pipe, the air inflow passage on the one-piece spray pipe, and the micro-bubble bubbler fixed at the outlet end of the one-piece spray pipe. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Preferably, the plurality of varying-diameter passages are evenly distributed in an annular form around the center of the one-piece spray pipe. This even annular distribution facilitates more air to be sucked in to perform gas-liquid premixing with the multiple streams of water flows.

Preferably, the bubbler includes a hole mesh and a hole mesh skeleton, and the hole mesh is attached to the outlet end of the one-piece spray pipe through the hole mesh skeleton. The hole mesh skeleton is provided with at least one overflow hole positioned close to the hole mesh. These overflow holes can prevent excess water from flooding the air inflow hole or other air inflow passages, thereby preventing a situation in which the micro-bubble water cannot be produced since the air cannot be sucked into the one-piece spray pipe due to blockage of the air inflow hole or other air inflow passages.

Preferably, the micro-bubble bubbler also includes a pressure ring, which is configured to be positioned between the hole mesh skeleton and the outlet end of the one-piece spray pipe to fix the hole mesh, and a plurality of pressure ring holes are provided on the pressure ring in a circumferential direction. On one hand, when a flow rate of sprayed water is not large, air can be sucked in through these pressure ring holes and mix with water to generate micro-bubble water; on the other hand, when the flow rate of sprayed water is too large, part of the water can overflow from these pressure ring holes. The overflow can not only help clean a surface of the hole mesh and take away dirt so as to improve a service life of the hole mesh, but also can prevent a phenomenon in which the micro-bubble water cannot be produced since the air cannot be sucked in due to blockage of the air inflow passage by excess water.

In a third embodiment, in order to solve the above problem in the prior art, that is, to solve the technical problem that existing micro-bubble generators have a complicated structure and the manufacturing cost is high, the present disclosure provides a micro-bubble spray head, which includes a one-piece spray pipe and a micro-bubble bubbler fixed at an outlet end of the one-piece spray pipe; a diameter-decreased conical passage part is provided in the one-piece spray pipe, and the diameter-decreased conical passage part is formed therein with a plurality of diameter-decreased conical passages parallel to each other in a water flow direction, so that multiple streams of water flows can be pressurized in the plurality of diameter-decreased conical passages and sprayed in an expanded state from outlets of the plurality of diameter-decreased conical passages to generate a negative pressure near the outlets; an air inflow passage is also provided on the one-piece spray pipe, and the air inflow passage is positioned close to the outlets so that air can be sucked in from the air inflow passage under the action of the negative pressure and mix with the multiple streams of water flows to generate bubble water, which becomes micro-bubble water under the action of the micro-bubble bubbler.

In a preferred technical solution of the above micro-bubble spray head, the diameter-decreased conical passage part is integrally formed with the one-piece spray pipe.

In a preferred technical solution of the above micro-bubble spray head, the diameter-decreased conical passage part is formed independently from the one-piece spray pipe.

In a preferred technical solution of the above micro-bubble spray head, the plurality of diameter-decreased conical passages are evenly distributed in an annular form around a center of the one-piece spray pipe.

In a preferred technical solution of the above micro-bubble spray head, the air inflow passage is a plurality of air inflow holes arranged on a pipe wall of the one-piece spray pipe, or the air inflow passage is formed between the outlet end and the micro-bubble bubbler.

In a preferred technical solution of the above micro-bubble spray head, the micro-bubble bubbler includes a hole mesh and a hole mesh skeleton, and the hole mesh is attached to the outlet end of the one-piece spray pipe through the hole mesh skeleton.

In a preferred technical solution of the above micro-bubble spray head, the hole mesh skeleton is provided with at least one overflow hole, and the at least one overflow hole is positioned close to the hole mesh.

In a preferred technical solution of the above micro-bubble spray head, the micro-bubble bubbler also includes a pressure ring, and the pressure ring is configured to be positioned between the hole mesh skeleton and the outlet end of the one-piece spray pipe to fix the hole mesh.

In a preferred technical solution of the above micro-bubble spray head, a plurality of pressure ring holes are provided on the pressure ring in a circumferential direction.

It can be understood by those skilled in the art that in the technical solutions of the present disclosure, the micro-bubble spray head includes a one-piece spray pipe and a micro-bubble bubbler installed at the outlet end of the one-piece spray pipe. A diameter-decreased conical passage part is provided in the one-piece spray pipe, and the diameter-decreased conical passage part is formed therein with a plurality of diameter-decreased conical passages parallel to each other in a water flow direction. A water flow entering the one-piece spray pipe is divided into multiple streams of water flows after entering the plurality of diameter-decreased conical passages. These multiple streams of water flows are respectively pressurized in the plurality of diameter-decreased conical passages, and are then sprayed in an expanded state from the outlets of the plurality of diameter-decreased conical passages to generate a negative pressure near the outlets. An air inflow passage is also provided on the one-piece spray pipe, and the air inflow passage is positioned close to the outlets of the plurality of diameter-decreased conical passages so that under the action of the negative pressure, a large amount of air is sucked into the one-piece spray pipe from the outside through the air inflow passage and mixes with the multiple streams of water flows to produce bubble water containing a large number of bubbles. The bubble water then flows through the micro-bubble bubbler located at the outlet end of the one-piece spray pipe so as to be cut and mixed by the micro-bubble bubbler, thereby producing micro-bubble water containing a large number of micro-bubbles. In the technical solutions of the micro-bubble spray head of the present disclosure, the function of producing micro-bubble water is realized by the diameter-decreased conical passage part having a plurality of diameter-decreased conical passages designed in the one-piece spray pipe, the air inflow passage on the one-piece spray pipe, and the micro-bubble bubbler fixed at the outlet end of the one-piece spray pipe. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Preferably, the plurality of diameter-decreased conical passages are evenly distributed in an annular form around the center of the one-piece spray pipe. This even annular distribution facilitates more air to be sucked in to perform gas-liquid premixing with the multiple streams of water flows.

Preferably, the bubbler includes a hole mesh and a hole mesh skeleton, and the hole mesh is attached to the outlet end of the one-piece spray pipe through the hole mesh skeleton. The hole mesh skeleton is provided with at least one overflow hole positioned close to the hole mesh. These overflow holes can prevent excess water from flooding the air inflow hole or other air inflow passages, thereby preventing a situation in which the micro-bubble water cannot be produced since the air cannot be sucked into the one-piece spray pipe due to blockage of the air inflow hole or other air inflow passages.

Preferably, the micro-bubble bubbler also includes a pressure ring, which is configured to be positioned between the hole mesh skeleton and the outlet end of the one-piece spray pipe to fix the hole mesh, and a plurality of pressure ring holes are provided on the pressure ring in a circumferential direction. On one hand, when a flow rate of sprayed water is not large, air can be sucked in through these pressure ring holes and mix with water to generate micro-bubble water; on the other hand, when the flow rate of sprayed water is too large, part of the water can overflow from these pressure ring holes. Such an overflow can not only help clean a surface of the hole mesh and take away dirt so as to improve a service life of the hole mesh, but also can prevent a phenomenon in which the micro-bubble water cannot be produced since the air cannot be sucked in due to blockage of the air inflow passage by excess water.

The present disclosure also provides a washing apparatus, which includes any of the micro-bubble spray heads as described above, and the micro-bubble spray head is configured to generate micro-bubble water in the washing apparatus. The micro-bubble spray head generates micro-bubble water containing a large number of micro-bubbles in the washing apparatus, so it can not only improve the cleaning ability of the washing apparatus, but also can reduce the amount of detergent used and a residual amount of detergent such as in the clothing.

### BRIEF DESCRIPTION OF DRAWINGS

Preferred embodiments of the present disclosure will be described below with reference to the accompanying drawings, in which:

FIG. 1 is a schematic structural view of an example of a washing apparatus including a micro-bubble spray head according to the present disclosure;

FIG. 2 is a schematic structural view of another example of the washing apparatus including the micro-bubble spray head according to the present disclosure;

FIG. 3 is a schematic perspective view of an example of the micro-bubble spray head according to the present disclosure;

FIG. 4 is a top view of the example of the micro-bubble spray head according to the present disclosure shown in FIG. 3;

FIG. 5 is a left side view of the example of the micro-bubble spray head according to the present disclosure shown in FIG. 3;

FIG. 6 is a front view of the example of the micro-bubble spray head according to the present disclosure shown in FIG. 3;

FIG. 7 is a cross-sectional view of an example of the micro-bubble spray head of the present disclosure in a first embodiment, taken along section line A-A in FIG. 6;

FIG. 8 is a cross-sectional view of another example of the micro-bubble spray head of the present disclosure in the first embodiment, taken along section line A-A in FIG. 6;

FIG. 9 is a cross-sectional view of an example of the micro-bubble spray head of the present disclosure in a second embodiment, taken along section line A-A in FIG. 6;

FIG. 10 is a cross-sectional view of another example of the micro-bubble spray head of the present disclosure in the second embodiment, taken along section line A-A in FIG. 6;

FIG. 11 is a cross-sectional view of an example of the micro-bubble spray head of the present disclosure in a third embodiment, taken along section line A-A in FIG. 6; and

FIG. 12 is a cross-sectional view of another example of the micro-bubble spray head of the present disclosure in the third embodiment, taken along section line A-A in FIG. 6.

connection part.

### DETAILED DESCRIPTION

Preferred embodiments of the present disclosure will be described below with reference to the accompanying drawings. It should be understood by those skilled in the art that these embodiments are only used to explain the technical principle of the present disclosure, and are not intended to limit the scope of protection of the present disclosure.

It should be noted that in the description of the present disclosure, terms indicating directional or positional relationships, such as “upper”, “lower”, “left”, “right”, “inner”, “outer” and the like, are based on the directional or positional relationships shown in the accompanying drawings. They are only used for ease of description, and do not indicate or imply that the device or element must have a specific orientation, or be constructed or operated in a specific orientation, and therefore they should not be considered as limitations to the present disclosure. In addition, terms “first” and “second” are only used for descriptive purposes, and should not be interpreted as indicating or implying relative importance.

In addition, it should also be noted that in the description of the present disclosure, unless otherwise clearly specified and defined, terms “install”, “arrange” and “connect” should be understood in a broad sense; for example, the connection may be a fixed connection, or may also be a detachable connection, or an integral connection; it may be a direct connection, or an indirect connection implemented through an intermediate medium, or it may be internal communication between two elements. For those skilled in the art, the specific meaning of the above terms in the present disclosure can be interpreted according to specific situations.

### First Embodiment

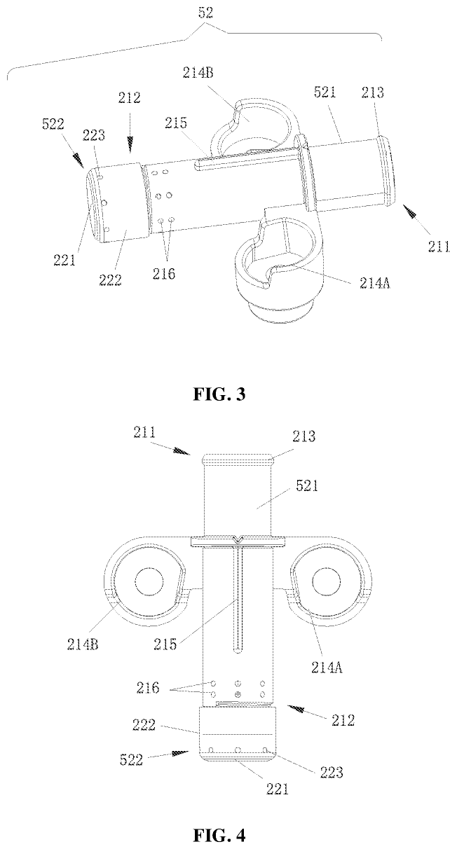

In order to solve the problem that existing micro-bubble generators have a complicated structure and the manufacturing cost is high, the present disclosure provides a micro-bubble spray head 52. The micro-bubble spray head 52 includes a one-piece spray pipe 521 and a micro-bubble bubbler 522 fixed at an outlet end 212 of the one-piece spray pipe 521 (see FIGS. 3 to 8). A throttling passage part 217 is provided in the one-piece spray pipe 521, and the throttling passage part 217 is formed therein with a plurality of equal-section throttling passages 218 parallel to each other in a water flow direction C, so that multiple streams of water flows can be formed in the plurality of equal-section throttling passages 218 and sprayed in an expanded state from outlets 218b of the plurality of equal-section throttling passages 218 to generate a negative pressure near the outlets 218b. An air inflow passage is also provided on the one-piece spray pipe 521, and the air inflow passage is positioned close to the outlets 218b so that air can be sucked in from the air inflow passage under the action of the negative pressure and mix with the multiple streams of water flows to generate bubble water, which becomes micro-bubble water under the action of the micro-bubble bubbler 522. Therefore, as compared with the micro-bubble generators in the prior art, the number of components and the structure of the micro-bubble spray head of the present disclosure are both greatly simplified, and the manufacturing cost of the micro-bubble spray head is also significantly reduced; at the same time, the micro-bubble spray head still maintains a good performance of micro-bubble generation.

The “equal-section” mentioned herein means that the cross-section of each throttling passage transverse to the water flow direction C remains unchanged.

The micro-bubble spray head 52 of the present disclosure can be applied in the field of washing, the field of sterilization, or other fields that require micro-bubbles. For example, the micro-bubble spray head 52 of the present disclosure can be applied not only to a washing apparatus, but also to devices such as bathroom faucets or showers.

Therefore, the present disclosure also provides a washing apparatus, which includes the micro-bubble spray head 52 of the present disclosure. The micro-bubble spray head 52 is configured to generate micro-bubble water in the washing apparatus. The micro-bubble water containing a large number of micro-bubbles is generated in the washing apparatus by the micro-bubble spray head. The micro-bubble water can not only improve the washing ability of the washing apparatus, but also can reduce the amount of detergent used and a residual amount of detergent such as in the clothing, which is not only advantageous for the user's health, but also can improve the user experience.

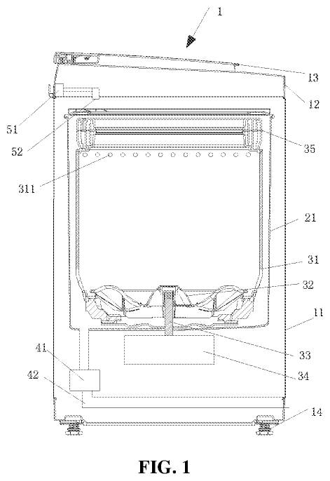

Reference is made to FIG. 1, which is a schematic structural view of an example of a washing apparatus including a micro-bubble spray head according to the present disclosure. In this example, the washing apparatus is a pulsator washing machine 1. Alternatively, in other examples, the washing apparatus may be a drum washing machine or a washing-drying integrated machine, etc.

As shown in FIG. 1, the pulsator washing machine 1 (hereinafter referred to as the washing machine) includes a cabinet 11. Feet 14 are provided at a bottom of the cabinet 11. An upper part of the cabinet 11 is provided with a tray 12, and the tray 12 is pivotally connected with an upper cover 13. An outer tub 21 serving as a water containing tub is provided inside the cabinet 11. An inner tub 31 is arranged in the outer tub 21, a pulsator 32 is arranged at a bottom of the inner tub 31, and a motor 34 is fixed at a lower part of the outer tub 21. The motor 34 is drivingly connected with the pulsator 32 through a transmission shaft 33. A spin-drying hole 311 is provided on a side wall of the inner tub 31, and washing water or water from the clothing can flow out of the inner tub 31 through the spin-drying hole 311 and flow into the outer tub 21. A drain valve 41 is provided on a drain pipe 42, and an upstream end of the drain pipe 42 communicates with a bottom of the outer tub 21. The pulsator washing machine 1 further includes a water inflow valve 51 and a micro-bubble spray head 52 communicating with the water inflow valve 51, and the micro-bubble spray head 52 is installed at a top of the outer tub 21. Water enters the micro-bubble spray head 52 through the water inflow valve 51 to generate micro-bubble water containing a large number of micro-bubbles. The micro-bubble spray head 52 sprays the micro-bubble water into a detergent box to mix with a detergent, and then the micro-bubble water enters the inner tub 31 through the detergent box for clothing washing. The micro-bubbles in the water impact the detergent during the breaking up process, and negative charges carried by the micro-bubbles can also adsorb the detergent, so the micro-bubbles can increase a mixing degree of the detergent and the water, thereby reducing the amount of detergent used and a residual amount of detergent in the clothing. In addition, the micro-bubbles in the inner tub 31 will also impact stains on the clothing, and will adsorb foreign matters that generate the stains. Therefore, the micro-bubbles also enhance a stain removal performance of the washing machine. Optionally, the micro-bubble spray head can also directly spray the micro-bubble water carrying a large number of micro-bubbles into the outer tub 21 or the inner tub 31 of the washing machine to further reduce the amount of detergent used and enhance the cleaning ability of the washing machine.

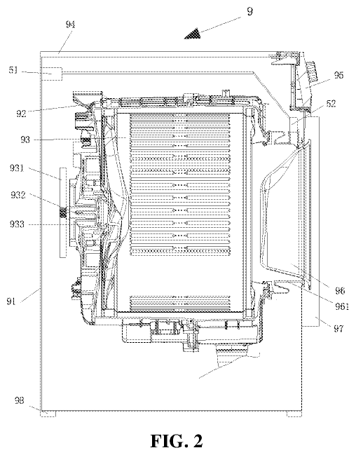

Reference is made to FIG. 2, which is a schematic structural view of another example of the washing apparatus including the micro-bubble spray head according to the present disclosure. In this example, the washing apparatus is a drum washing machine 9.

As shown in FIG. 2, the drum washing machine 9 includes a shell 91 and feet 98 located at a bottom of the shell. A top panel 94 is provided at a top of the shell 91. A front side of the shell 91 (an operation side facing the user) is provided with a door 97 that allows the user to put clothing and the like into the drum washing machine, and the door 97 is also provided with an observation window 96 for viewing an interior of the washing machine. A sealing window gasket 961 is also provided between the observation window 96 and the shell 91, and the sealing window gasket 961 is fixed on the shell 91. A control panel 95 of the drum washing machine 9 is arranged on an upper part of the front side of the shell 91 to facilitate the user's operation. An outer cylinder 92 and an inner cylinder 93 are arranged inside the shell 91. The inner cylinder 93 is positioned inside the outer cylinder 92. The inner cylinder 93 is connected to a motor 931 (e.g., a direct drive motor) through a transmission shaft 932 and a bearing 933. A water inflow valve 51 is provided on an upper part of a rear side of the shell 91, and the water inflow valve 51 is connected to a micro-bubble spray head 52 through a water pipe. As shown in FIG. 2, the micro-bubble spray head 52 is positioned close to the upper part of the front side of the shell 91 and located below the control panel 95. Similar to the above example, water enters the micro-bubble spray head 52 through the water pipe from the water inflow valve 51 to generate micro-bubble water containing a large number of micro-bubbles. The micro-bubble spray head 52 first sprays the micro-bubble water into a detergent box to mix with a detergent, and then the micro-bubble water enters the inner cylinder 93 through the detergent box for clothing washing. Optionally, the micro-bubble spray head 52 can also directly spray the micro-bubble water carrying a large number of micro-bubbles into the outer cylinder 92 or the inner cylinder 93 of the washing machine to further reduce the amount of detergent used and enhance the cleaning ability of the washing machine.

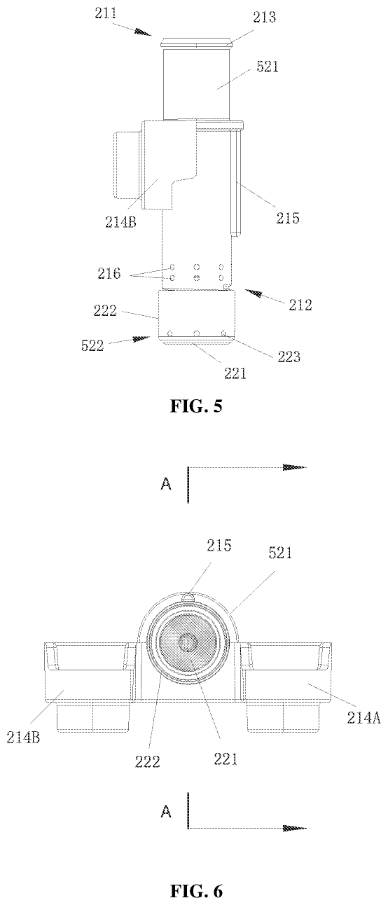

Reference is made to FIGS. 3 to 6, which are schematic views of an example of the micro-bubble spray head according to the present disclosure, in which FIG. 3 is a schematic perspective view of the example of the micro-bubble spray head according to the present disclosure, FIG. 4 is a top view of the example of the micro-bubble spray head according to the present disclosure shown in FIG. 3, FIG. 5 is a left side view of the example of the micro-bubble spray head according to the present disclosure shown in FIG. 3, and FIG. 6 is a front view of the example of the micro-bubble spray head according to the present disclosure shown in FIG. 3. As shown in FIGS. 3 to 6, in one or more examples, the micro-bubble spray head 52 of the present disclosure includes a one-piece spray pipe 521. A micro-bubble bubbler 522 is fixed at an outlet end 212 of the one-piece spray pipe 521, and the micro-bubble bubbler 522 is configured to be capable of cutting and mixing the bubble water when the bubble water flow through the micro-bubble bubbler 522 to produce micro-bubble water containing a large number of micro-bubbles.

Referring to FIG. 3, in one or more examples, the one-piece spray pipe 521 has an inlet end 211 and the outlet end 212. The micro-bubble bubbler 522 is fixed on the outlet end 212, and the inlet end 211 is configured to be connected to an external water source. Optionally, an anti-disengagement part 213 may be provided on the inlet end 211, such as an anti-disengagement rib protruding radially outward around an outer wall of the inlet end 211 or an annular groove structure recessed inward from the outer wall of the inlet end 211. The anti-disengagement part can prevent the one-piece spray pipe 521 from falling off a connected pipeline which provides water supply.

With continued reference to FIG. 3, in one or more examples, the outer wall of the one-piece spray pipe 521 is provided with a first fixed installation part 214A, a second fixed installation part 214B, and a positioning part 215, which are used to position and fix the micro-bubble spray head 52 to a predetermined position.

With reference to FIGS. 4 to 6, the first fixed installation part 214A and the second fixed installation part 214B are symmetrically positioned on the outer wall of the one-piece spray pipe 521, and are located in the middle of the one-piece spray pipe 521. The positioning part 215 is a long-strip-shaped rib, which protrudes radially outward from the outer wall of the one-piece spray pipe 521 and extends in a longitudinal direction of the one-piece spray pipe 521. The first fixed installation part 214A and the second fixed installation part 214B are distributed on both sides of the positioning part 215. Optionally, only one fixed installation part is provided on the one-piece spray pipe 521, and the positioning part 215 may also be in other suitable forms.

In one or more examples, the first and second fixed installation parts 214A, 214B are screw hole structures so that the spray head 52 can be fixed to a target position by screws. However, the fixed installation parts may be any suitable connection structure in other forms, such as a snap-fit connection structure, a welded connection structure, and the like.

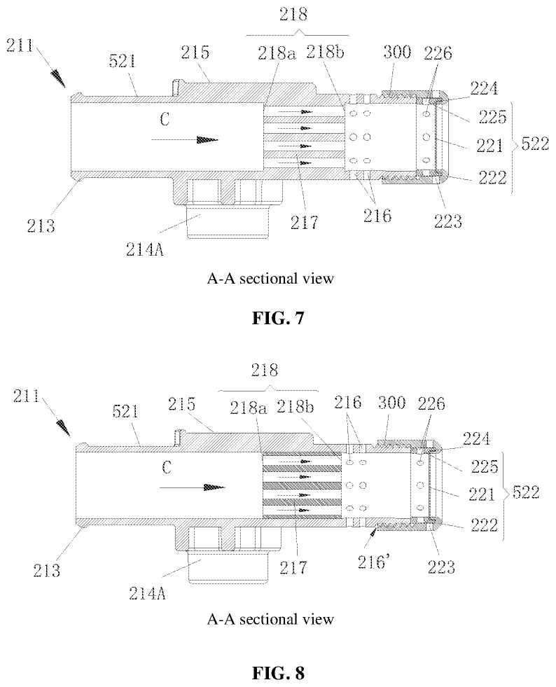

FIG. 7 is a cross-sectional view of an example of the micro-bubble spray head of the present disclosure in the first embodiment, taken along section line A-A in FIG. 6. As shown in FIG. 7, a throttling passage part 217 is arranged in the one-piece spray pipe 521 in the water flow direction C. In one or more examples, the throttling passage part 217 is integrally formed with the one-piece spray pipe 521, such as by integral injection molding. In an alternative example, the throttling passage part 217 is formed independently from the one-piece spray pipe 521, and is then inserted into the one-piece spray pipe 521 and snap-fitted in the one-piece spray pipe 521. Alternatively, the independently formed throttling passage part 217 can also be press-fitted into the one-piece spray pipe 521.

Referring to FIG. 7, a plurality of equal-section throttling passages 218 are provided in the throttling passage part 217. In one or more examples, the number of equal-section throttling passages 218 is two (2) to sixteen (16), and these equal-section throttling passages are evenly distributed in an annular form around a centerline of the one-piece spray pipe 521. Alternatively, the number of equal-section throttling passages 218 may be six (6) to nine (9). Optionally, these equal-section throttling passages may also be arranged in other forms than annular and may not be evenly distributed. In one or more examples, the sections of all the equal-section throttling passages 218 transverse to the water flow direction C are the same. Alternatively, these equal-section throttling passages 218 may also have different cross sections; for example, the equal-section throttling passage near the center of the one-piece spray pipe 521 has a larger cross-section than the equal-section throttling passage away from the center of the one-piece spray pipe 521.

With continued reference to FIG. 7, each equal-section throttling passage 218 includes an inlet 218a and an outlet 218b. A water flow flowing from the inlet end 211 of the one-piece spray pipe 521 enters from the inlet 218a of each equal-section throttling passage 218 and is thus divided into multiple streams of water flows. The multiple streams of water flows are pressurized in the corresponding equal-section throttling passages 218, and are rapidly expanded when they are sprayed from the outlets 218b of the plurality of equal-section throttling passages 218, so that a negative pressure region is generated near the outlets 218b of the plurality of equal-section throttling passages 218.

As shown in FIG. 7, a plurality of air inflow holes 216 serving as the air inflow passage are formed on the outer wall of the one-piece spray pipe 521. These air inflow holes 216 are arranged into two rings around the outer wall of the one-piece spray pipe 521, and these air inflow holes 216 are positioned close to the outlets 218b of the equal-section throttling passages 218, so they are in the negative pressure region. Under the action of the negative pressure, a large amount of outside air can be sucked into the one-piece spray pipe 521 from the air inflow holes 216 and mix with the multiple streams of water flows sprayed from the plurality of equal-section throttling passages 218 to generate bubble water. The bubble water then flows to the downstream micro-bubble bubbler 522 to form micro-bubble water. In an alternative example, more or fewer air inflow holes may be provided as needed, and they may be arranged in other forms, such as in a staggered arrangement.

The micro-bubble bubbler 522 at the outlet end 212 of the one-piece spray pipe 521 includes a hole mesh 221 and a hole mesh skeleton 222. The hole mesh 221 is attached to the outlet end 212 of the one-piece spray pipe 521 through the hole mesh skeleton 222.

In one or more examples, the hole mesh 221 has at least one fine hole having a diameter reaching a micron scale. Preferably, the diameter of the fine hole is between 0 and 1000 microns; more preferably, the diameter of the fine hole is between 5 microns and 500 microns. The hole mesh 221 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the hole mesh 221 may be other hole mesh structures capable of generating micro-bubbles, such as a hole mesh structure composed of two non-micron-scale honeycomb structures. When the bubble water flows through the hole mesh 221, the hole mesh 221 mixes and cuts the bubble water, thereby generating micro-bubble water.

Referring to FIG. 7, the hole mesh skeleton 222 is cylindrical so that it can be sleeved over the outlet end 212 of the one-piece spray pipe 521. In one or more examples, the hole mesh skeleton 222 and the outlet end 212 of the one-piece spray pipe are fixed together by a threaded connection part 300. For example, internal threads are formed on an inner wall of the hole mesh skeleton 222, and external threads are formed on an outer wall of the outlet end 212, in which the internal threads and the external threads are meshed together. In an alternative example, the hole mesh skeleton 222 may take other suitable forms, such as a pressing plate, and it can connected to the outlet end of the one-piece spray pipe 521 through other connection means, such as welding. Optionally, the hole mesh can also be formed directly on the outlet end 212 of the one-piece spray pipe.

As shown in FIGS. 3-7, in one or more examples, the hole mesh skeleton 222 is provided with a plurality of overflow holes 223 along its periphery, and these overflow holes are positioned close to the hole mesh 221. When the bubble water cannot pass through the hole mesh 221 in time, the excess bubble water can flow out from the overflow holes 223, thereby preventing the excess water from flowing back and flooding the air inflow holes 216. Therefore, the overflow holes 223 can prevent a situation in which the air cannot be sucked into the one-piece spray pipe due to the blockage of the air inflow holes 216 so that the micro-bubble water cannot be generated. In alternative examples, more or fewer overflow holes 223 may be provided as needed.

With continued reference to FIG. 7, in one or more examples, a pressure ring 225 is also provided between the hole mesh skeleton 222 and the outlet end 212 of the one-piece spray pipe 521. Correspondingly, a connection part 224 is provided on the periphery of the hole mesh 221. The pressure ring 225 presses the connection part 224 on the inner wall of the end of the hole mesh skeleton 222, so that the hole mesh 221 can be firmly fixed, and that the hole mesh 221 will not fall off the outlet end 212 of the one-piece spray pipe 521 when it is impacted by high-pressure water flow. In an alternative example, the hole mesh 221 can also be fixed by using other structures; for example, the hole mesh is clamped by a circlip. In one or more examples, the pressure ring 225 is also provided with a plurality of pressure ring holes 226. When a flow rate of sprayed water flow is not large, these pressure ring holes 226 can be used to suck in air so that the air mixes with the water flow. When the flow rate of sprayed water flow is relatively large, these pressure ring holes 226 allow some water to overflow from them, which can not only help clean the hole mesh, but also can prevent excess water from flowing backward through the air inflow passage to cause the inability to suck in air through the air inflow passage.

FIG. 8 is a cross-sectional view of another example of the micro-bubble spray head of the present disclosure in the first embodiment, taken along section line A-A in FIG. 6. As shown in FIG. 8, in this embodiment, the throttling passage part 217 is formed independently from the one-piece spray pipe 521 by injection molding. In addition, in this embodiment, the hole mesh skeleton 222 and the outlet end 212 of the one-piece spray pipe are also fixed together by the threaded connection part 300, and a threaded air inflow passage 216′ is formed in the threaded connection part 300; for example, the threaded air inflow passage 216′ is a gap formed between external threads and internal threads. Therefore, in this embodiment, the air inflow passage not only includes the air inflow holes 216 on the outer wall of the one-piece spray pipe 521, but also includes the threaded air inflow passage 216′. In an alternative embodiment, the air inflow passage of the spray head 52 may also only include an air inflow passage provided between the outlet end of the one-piece spray pipe 521 and the micro-bubble bubbler.

### Second Embodiment

In order to solve the problem that existing micro-bubble generators have a complicated structure and the manufacturing cost is high, the present disclosure provides a micro-bubble spray head 52. The micro-bubble spray head 52 includes a one-piece spray pipe 521 and a micro-bubble bubbler 522 fixed at an outlet end 212 of the one-piece spray pipe 521 (see FIGS. 3 to 6 and 9 to 10). A varying-diameter passage part 217 is provided in the one-piece spray pipe 521. The varying-diameter passage part 217 is formed therein with a plurality of varying-diameter passages 218 parallel to each other in a water flow direction C, and each of the varying-diameter passages 218 includes a diameter-decreased conical passage 218a and a diameter-increased conical passage 218c in sequence in the water flow direction C. A water flow that can be pressurized (also accelerated at the same time) by the diameter-decreased conical passage 218 can be expanded in the diameter-increased conical passage 218c to generate a negative pressure near an outlet 218d of the varying-diameter passage 218. An air inflow passage is also provided on the one-piece spray pipe 521, and the air inflow passage is positioned close to the outlets 218d so that air can be sucked in from the air inflow passage under the action of the negative pressure and mix with multiple streams of water flows from the plurality of varying-diameter passages 218 to generate bubble water, which becomes micro-bubble water under the action of the micro-bubble bubbler 522. Therefore, as compared with the micro-bubble generators in the prior art, the number of components and the structure of the micro-bubble spray head of the present disclosure are both greatly simplified, and the manufacturing cost of the micro-bubble spray head is also significantly reduced; at the same time, the micro-bubble spray head still maintains a good performance of micro-bubble generation.

The “varying-diameter passage” mentioned herein means that a size (e.g., diameter) of each passage transverse to the water flow direction C varies. The micro-bubble spray head of the present disclosure can be applied in the field of washing, the field of sterilization, or other fields that require micro-bubbles. For example, the micro-bubble spray head of the present disclosure can be applied not only to a washing apparatus, but also to devices such as bathroom faucets or showers.

Therefore, the present disclosure also provides a washing apparatus, which includes the micro-bubble spray head 52 of the present disclosure. The micro-bubble spray head 52 is configured to generate micro-bubble water in the washing apparatus. The micro-bubble water containing a large number of micro-bubbles is generated in the washing apparatus by the micro-bubble spray head. The micro-bubble water can not only improve the washing ability of the washing apparatus, but also can reduce the amount of detergent used and a residual amount of detergent such as in the clothing, which is not only advantageous for the user's health, but also can improve the user experience.

Reference is made to FIG. 1, which is a schematic structural view of an example of a washing apparatus including a micro-bubble spray head according to the present disclosure. In this example, the washing apparatus is a pulsator washing machine 1. Alternatively, in other examples, the washing apparatus may be a drum washing machine or a washing-drying integrated machine, etc.

As shown in FIG. 1, the pulsator washing machine 1 (hereinafter referred to as the washing machine) includes a cabinet 11. Feet 14 are provided at a bottom of the cabinet 11. An upper part of the cabinet 11 is provided with a tray 12, and the tray 12 is pivotally connected with an upper cover 13. An outer tub 21 serving as a water containing tub is provided inside the cabinet 11. An inner tub 31 is arranged in the outer tub 21, a pulsator 32 is arranged at a bottom of the inner tub 31, and a motor 34 is fixed at a lower part of the outer tub 21. The motor 34 is drivingly connected with the pulsator 32 through a transmission shaft 33. A spin-drying hole 311 is provided on a side wall of the inner tub 31, and washing water or water from the clothing can flow out of the inner tub 31 through the spin-drying hole and flow into the outer tub 21. A drain valve 41 is provided on a drain pipe 42, and an upstream end of the drain pipe 42 communicates with a bottom of the outer tub 21. The washing machine further includes a water inflow valve 51 and a micro-bubble spray head 52 communicating with the water inflow valve 51, and the micro-bubble spray head 52 is installed at a top of the outer tub 21. Water enters the micro-bubble spray head 52 through the water inflow valve 51 to generate micro-bubble water containing a large number of micro-bubbles. The micro-bubble spray head 52 sprays the micro-bubble water into a detergent box to mix with a detergent, and then the micro-bubble water enters the inner tub 31 through the detergent box for clothing washing. The micro-bubbles in the water impact the detergent during the breaking up process, and negative charges carried by the micro-bubbles can also adsorb the detergent, so the micro-bubbles can increase a mixing degree of the detergent and the water, thereby reducing the amount of detergent used and a residual amount of detergent in the clothing. In addition, the micro-bubbles in the inner tub 31 will also impact stains on the clothing, and will adsorb foreign matters that generate the stains. Therefore, the micro-bubbles also enhance a stain removal performance of the washing machine. Optionally, the micro-bubble spray head can also directly spray the micro-bubble water carrying a large number of micro-bubbles into the outer tub 21 or the inner tub 31 of the washing machine to further reduce the amount of detergent used and enhance the cleaning ability of the washing machine.

Reference is made to FIG. 2, which is a schematic structural view of another example of the washing apparatus including the micro-bubble spray head according to the present disclosure. In this example, the washing apparatus is a drum washing machine 9.

As shown in FIG. 2, the drum washing machine 9 includes a shell 91 and feet 98 located at a bottom of the shell. A top panel 94 is provided at a top of the shell 91. A front side of the shell 91 (an operation side facing the user) is provided with a door 97 that allows the user to put clothing and the like into the drum washing machine, and the door 97 is also provided with an observation window 96 for viewing an interior of the washing machine. A sealing window gasket 961 is also provided between the observation window 96 and the shell 91, and the sealing window gasket 961 is fixed on the shell 91. A control panel 95 of the drum washing machine 9 is arranged on an upper part of the front side of the shell 91 to facilitate the user's operation. An outer cylinder 92 and an inner cylinder 93 are arranged inside the shell 91. The inner cylinder 93 is positioned inside the outer cylinder 92. The inner cylinder 93 is connected to a motor 931 (e.g., a direct drive motor) through a transmission shaft 932 and a bearing 933. A water inflow valve 51 is provided on an upper part of a rear side of the shell 91, and the water inflow valve 51 is connected to a micro-bubble spray head 52 through a water pipe. As shown in FIG. 2, the micro-bubble spray head 52 is positioned close to the upper part of the front side of the shell 91 and located below the control panel 95. Similar to the above example, water enters the micro-bubble spray head 52 through the water pipe from the water inflow valve 51 to generate micro-bubble water containing a large number of micro-bubbles. The micro-bubble spray head 52 first sprays the micro-bubble water into a detergent box to mix with a detergent, and then the micro-bubble water enters the inner cylinder 93 through the detergent box for clothing washing. Optionally, the micro-bubble spray head 52 can also directly spray the micro-bubble water carrying a large number of micro-bubbles into the outer cylinder 92 or the inner cylinder 93 of the washing machine to further reduce the amount of detergent used and enhance the cleaning ability of the washing machine.

Reference is made to FIGS. 3 to 6, which are schematic views of an example of the micro-bubble spray head according to the present disclosure, in which FIG. 3 is a schematic perspective view of the example of the micro-bubble spray head according to the present disclosure, FIG. 4 is a top view of the example of the micro-bubble spray head according to the present disclosure shown in FIG. 3, FIG. 5 is a left side view of the example of the micro-bubble spray head according to the present disclosure shown in FIG. 3, and FIG. 6 is a front view of the example of the micro-bubble spray head according to the present disclosure shown in FIG. 3. As shown in FIGS. 3 to 6, in one or more examples, the micro-bubble spray head 52 of the present disclosure includes a one-piece spray pipe 521. A micro-bubble bubbler 522 is fixed at an outlet end 212 of the one-piece spray pipe 521, and the micro-bubble bubbler 522 is configured to be capable of cutting and mixing the bubble water when the bubble water flow through the micro-bubble bubbler 522 to produce micro-bubble water containing a large number of micro-bubbles.

Referring to FIG. 3, in one or more examples, the one-piece spray pipe 521 has an inlet end 211 and the outlet end 212. The micro-bubble bubbler 522 is fixed on the outlet end 212, and the inlet end 211 is configured to be connected to an external water source. Optionally, an anti-disengagement part 213 may be provided on the inlet end 211, such as an anti-disengagement rib protruding radially outward around an outer wall of the inlet end 211 or an annular groove structure recessed inward from the outer wall of the inlet end 211. The anti-disengagement part can prevent the one-piece spray pipe 521 from falling off a connected pipeline which provides water supply.

With continued reference to FIG. 3, in one or more examples, the outer wall of the one-piece spray pipe 521 is provided with a first fixed installation part 214A, a second fixed installation part 214B, and a positioning part 215, which are used to position and fix the micro-bubble spray head 52 to a predetermined position.

With reference to FIGS. 4 to 6, the first fixed installation part 214A and the second fixed installation part 214B are symmetrically positioned on the outer wall of the one-piece spray pipe 521, and are located in the middle of the one-piece spray pipe 521. The positioning part 215 is a long-strip-shaped rib, which protrudes radially outward from the outer wall of the one-piece spray pipe 521 and extends in a longitudinal direction of the one-piece spray pipe 521. The first fixed installation part 214A and the second fixed installation part 214B are distributed on both sides of the positioning part 215. Optionally, only one fixed installation part is provided on the one-piece spray pipe 521, and the positioning part 215 may also be in other suitable forms.

In one or more examples, the first and second fixed installation parts 214A, 214B are screw hole structures so that the spray head 52 can be fixed to a target position by screws. However, the fixed installation parts may be any suitable connection structure, such as a snap-fit connection structure, a welded connection structure, and the like.

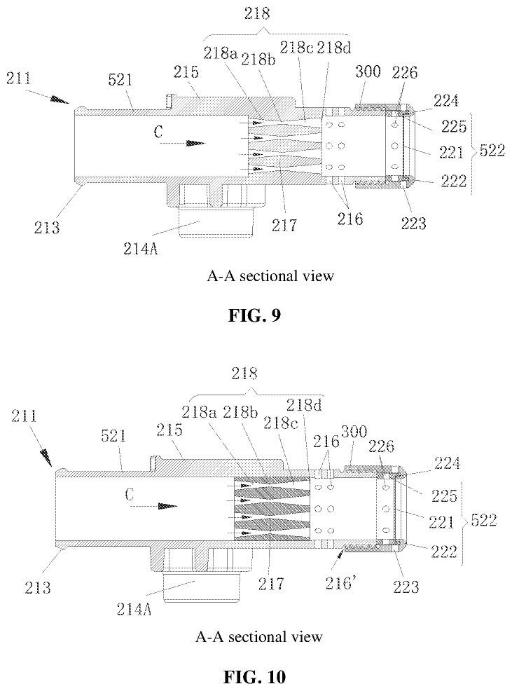

FIG. 9 is a cross-sectional view of an example of the micro-bubble spray head of the present disclosure in the second embodiment, taken along section line A-A in FIG. 6. As shown in FIG. 9, a varying-diameter passage part 217 is arranged in the one-piece spray pipe 521 in the water flow direction C. In one or more examples, the varying-diameter passage part 217 is integrally formed with the one-piece spray pipe 521, such as by integral injection molding. In an alternative example, the varying-diameter passage part 217 is formed independently from the one-piece spray pipe 521, and is then inserted into the one-piece spray pipe 521 and snap-fitted in the one-piece spray pipe 521. Alternatively, the independently formed varying-diameter passage part 217 can also be press-fitted into the one-piece spray pipe 521.

Referring to FIG. 9, a plurality of varying-diameter passages 218 are provided in the varying-diameter passage part 217. In one or more examples, the number of varying-diameter passages 218 is two (2) to sixteen (16), and these varying-diameter passages are evenly distributed in an annular form around a centerline of the one-piece spray pipe 521. Alternatively, the number of varying-diameter passages 218 may be six (6) to nine (9). Optionally, these varying-diameter passages may also be arranged in other forms than annular and may not be evenly distributed. In one or more examples, the configurations of all the varying-diameter passages 218 are the same. Alternatively, these varying-diameter passages 218 may also have different configurations; for example, at the same radial position perpendicular to the water flow direction C, the diameter (and thus the cross section) of the varying-diameter passage 218 near the center of the one-piece spray pipe 521 is larger than the diameter (and thus the cross section) of the varying-diameter passage 218 away from the center of the one-piece spray pipe 521.

With continued reference to FIG. 9, each varying-diameter passage 218 includes a diameter-decreased conical passage 218a and a diameter-increased conical passage 218c. In the water flow direction C, a downstream smallest-diameter end of the diameter-decreased conical passage 218a coincides with an upstream smallest-diameter end of the diameter-increased conical passage 218c, thus forming a smallest-diameter passage 218b. A water flow flowing from the inlet end 211 of the one-piece spray pipe 521 first enters the diameter-decreased conical passage 218a of each varying-diameter passage 218 and is pressurized therein, then passes through the smallest-diameter passage 218b before entering the diameter-increased conical passage 218c. In the diameter-increased conical passage 218c, the water flow is rapidly expanded. Therefore, after the expanded water flow is sprayed from the outlet 218d of the diameter-increased conical passage 218c (which is also the outlet 2 of the varying-diameter passage 218), a negative pressure region will be generated near the outlet 218d.

As shown in FIG. 9, a plurality of air inflow holes 216 serving as the air inflow passage are formed on the outer wall of the one-piece spray pipe 521. These air inflow holes 216 are arranged into two rings around the outer wall of the one-piece spray pipe 521, and these air inflow holes 216 are positioned close to the outlets 218d of the varying-diameter passages 218, so they are in the negative pressure region. Under the action of the negative pressure, a large amount of outside air can be sucked into the one-piece spray pipe 521 from the air inflow holes 216 and mix with the multiple streams of water flows sprayed from the plurality of varying-diameter passages 218 to generate bubble water. The bubble water then flows to the downstream micro-bubble bubbler 522 to form micro-bubble water. In an alternative example, more or fewer air inflow holes may be provided as needed, and they may be arranged in other forms, such as in a staggered arrangement.

The micro-bubble bubbler 522 at the outlet end 212 of the one-piece spray pipe 521 includes a hole mesh 221 and a hole mesh skeleton 222. The hole mesh 221 is attached to the outlet end 212 of the one-piece spray pipe 521 through the hole mesh skeleton 222.

In one or more examples, the hole mesh 221 has at least one fine hole having a diameter reaching a micron scale. Preferably, the diameter of the fine hole is between 0 and 1000 microns; more preferably, the diameter of the fine hole is between 5 microns and 500 microns. The hole mesh 221 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the hole mesh 221 may be other hole mesh structures capable of generating micro-bubbles, such as a hole mesh structure composed of two non-micron-scale honeycomb structures. When the bubble water flows through the hole mesh 221, the hole mesh 221 mixes and cuts the bubble water, thereby generating micro-bubble water.

Referring to FIG. 9, the hole mesh skeleton 222 is cylindrical so that it can be sleeved over the outlet end 212 of the one-piece spray pipe 521. In one or more examples, the hole mesh skeleton 222 and the outlet end 212 of the one-piece spray pipe are fixed together by a threaded connection part 300. For example, internal threads are formed on an inner wall of the hole mesh skeleton 222, and external threads are formed on an outer wall of the outlet end 212, in which the internal threads and the external threads are meshed together. In an alternative example, the hole mesh skeleton 222 may take other suitable forms, such as a pressing plate, and it can connected to the outlet end of the one-piece spray pipe 521 through other connection means, such as welding. Optionally, the hole mesh can also be formed directly on the outlet end 212 of the one-piece spray pipe.

As shown in FIGS. 3-6 and 9, in one or more examples, the hole mesh skeleton 222 is provided with a plurality of overflow holes 223 along its periphery, and these overflow holes are positioned close to the hole mesh 221. When the bubble water cannot pass through the hole mesh 221 in time, the excess bubble water can flow out from the overflow holes 223, thereby preventing the excess water from flowing back and flooding the air inflow holes 216. Therefore, the overflow holes 223 can prevent a situation in which the air cannot be sucked into the one-piece spray pipe due to the blockage of the air inflow holes 216 so that the micro-bubble water cannot be generated. In alternative examples, more or fewer overflow holes 223 may be provided as needed.

With continued reference to FIG. 9, in one or more examples, a pressure ring 225 is also provided between the hole mesh skeleton 222 and the outlet end 212 of the one-piece spray pipe 521. Correspondingly, a connection part 224 is provided on the periphery of the hole mesh 221. The pressure ring 225 presses the connection part 224 on the inner wall of the end of the hole mesh skeleton 222, so that the hole mesh 221 can be firmly fixed, and that the hole mesh 221 will not fall off the outlet end 212 of the one-piece spray pipe 521 when it is impacted by high-pressure water flow. In an alternative example, the hole mesh 221 can also be fixed by using other structures; for example, the hole mesh is clamped by a circlip. In one or more examples, the pressure ring 225 is also provided with a plurality of pressure ring holes 226. When a flow rate of sprayed water flow is not large, these pressure ring holes 226 can be used to suck in air so that the air mixes with the water flow. When the flow rate of sprayed water flow is relatively large, these pressure ring holes 226 allow some water to overflow from them, which can not only help clean the hole mesh, but also can prevent excess water from flowing backward through the air inflow passage to cause the inability to suck in air through the air inflow passage.

FIG. 10 is a cross-sectional view of another example of the micro-bubble spray head of the present disclosure in the second embodiment, taken along section line A-A in FIG. 6. As shown in FIG. 10, in this embodiment, the varying-diameter passage part 217 is formed independently from the one-piece spray pipe 521 by injection molding. In addition, in this embodiment, the hole mesh skeleton 222 and the outlet end 212 of the one-piece spray pipe are also fixed together by the threaded connection part 300, and a threaded air inflow passage 216′ is formed in the threaded connection part 300; for example, the threaded air inflow passage 216′ is a gap formed between external threads and internal threads. Therefore, in this embodiment, the air inflow passage not only includes the air inflow holes 216 on the outer wall of the one-piece spray pipe 521, but also includes the threaded air inflow passage 216′. In an alternative embodiment, the air inflow passage of the spray head 52 may also only include an air inflow passage provided between the outlet end of the one-piece spray pipe 521 and the micro-bubble bubbler.

### Third Embodiment

In order to solve the problem that existing micro-bubble generators have a complicated structure and the manufacturing cost is high, the present disclosure provides a micro-bubble spray head 52. The micro-bubble spray head 52 includes a one-piece spray pipe 521 and a micro-bubble bubbler 522 fixed at an outlet end 212 of the one-piece spray pipe 521 (see FIGS. 3 to 8). A diameter-decreased conical passage part 217 is provided in the one-piece spray pipe 521. The diameter-decreased conical passage part 217 is formed therein with a plurality of diameter-decreased conical passages 218 parallel to each other in a water flow direction C, so that multiple streams of water flows can be formed in the plurality of diameter-decreased conical passages 218 and sprayed in an expanded state from outlets 218b of the plurality of diameter-decreased conical passages 218 to generate a negative pressure near the outlets 218b. An air inflow passage is also provided on the one-piece spray pipe 521, and the air inflow passage is positioned close to the outlets 218b so that air can be sucked in from the air inflow passage under the action of the negative pressure and mix with the multiple streams of water flows to generate bubble water, which becomes micro-bubble water under the action of the micro-bubble bubbler 522. Therefore, as compared with the micro-bubble generators in the prior art, the number of components and the structure of the micro-bubble spray head of the present disclosure are both greatly simplified, and the manufacturing cost of the micro-bubble spray head is also significantly reduced; at the same time, the micro-bubble spray head also has a good performance of micro-bubble generation.

The “diameter-decreased conical passage” mentioned herein means that the diameter of each passage gradually decreases in the water flow direction C to form a substantially conical passage.

The micro-bubble spray head 52 of the present disclosure can be applied in the field of washing, the field of sterilization, or other fields that require micro-bubbles. For example, the micro-bubble spray head 52 of the present disclosure can be applied not only to a washing apparatus, but also to devices such as bathroom faucets or showers.

Therefore, the present disclosure also provides a washing apparatus, which includes the micro-bubble spray head 52 of the present disclosure. The micro-bubble spray head 52 is configured to generate micro-bubble water in the washing apparatus. The micro-bubble water containing a large number of micro-bubbles is generated in the washing apparatus by the micro-bubble spray head. The micro-bubble water can not only improve the washing ability of the washing apparatus, but also can reduce the amount of detergent used and a residual amount of detergent such as in the clothing, which is not only advantageous for the user's health, but also can improve the user experience.

Reference is made to FIG. 1, which is a schematic structural view of an example of a washing apparatus including a micro-bubble spray head according to the present disclosure. In this example, the washing apparatus is a pulsator washing machine 1. Alternatively, in other examples, the washing apparatus may be a drum washing machine or a washing-drying integrated machine, etc.

As shown in FIG. 1, the pulsator washing machine 1 (hereinafter referred to as the washing machine) includes a cabinet 11. Feet 14 are provided at a bottom of the cabinet 11. An upper part of the cabinet 11 is provided with a tray 12, and the tray 12 is pivotally connected with an upper cover 13. An outer tub 21 serving as a water containing tub is provided inside the cabinet 11. An inner tub 31 is arranged in the outer tub 21, a pulsator 32 is arranged at a bottom of the inner tub 31, and a motor 34 is fixed at a lower part of the outer tub 21. The motor 34 is drivingly connected with the pulsator 32 through a transmission shaft 33. A spin-drying hole 311 is provided on a side wall of the inner tub 31, and washing water or water from the clothing can flow out of the inner tub 31 through the spin-drying hole 311 and flow into the outer tub 21. A drain valve 41 is provided on a drain pipe 42, and an upstream end of the drain pipe 42 communicates with a bottom of the outer tub 21. The pulsator washing machine 1 further includes a water inflow valve 51 and a micro-bubble spray head 52 communicating with the water inflow valve 51, and the micro-bubble spray head 52 is installed at a top of the outer tub 21. Water enters the micro-bubble spray head 52 through the water inflow valve 51 to generate micro-bubble water containing a large number of micro-bubbles. The micro-bubble spray head 52 sprays the micro-bubble water into a detergent box to mix with a detergent (or other clothing treatment agents), and then the micro-bubble water enters the inner tub 31 through the detergent box for clothing washing. The micro-bubbles in the water impact the detergent during the breaking up process, and negative charges carried by the micro-bubbles can also adsorb the detergent, so the micro-bubbles can increase a mixing degree of the detergent and the water, thereby reducing the amount of detergent used and a residual amount of detergent in the clothing. In addition, the micro-bubbles in the inner tub 31 will also impact stains on the clothing, and will adsorb foreign matters that generate the stains. Therefore, the micro-bubbles also enhance a stain removal performance of the washing machine. Optionally, the micro-bubble spray head can also directly spray the micro-bubble water carrying a large number of micro-bubbles into the outer tub 21 or the inner tub 31 of the washing machine to further reduce the amount of detergent used and enhance the cleaning ability of the washing machine.

Reference is made to FIG. 2, which is a schematic structural view of another example of the washing apparatus including the micro-bubble spray head according to the present disclosure. In this example, the washing apparatus is a drum washing machine 9.

As shown in FIG. 2, the drum washing machine 9 includes a shell 91 and feet 98 located at a bottom of the shell. A top panel 94 is provided at a top of the shell 91. A front side of the shell 91 (an operation side facing the user) is provided with a door 97 that allows the user to put clothing and the like into the drum washing machine, and the door 97 is also provided with an observation window 96 for viewing an interior of the washing machine. A sealing window gasket 961 is also provided between the observation window 96 and the shell 91, and the sealing window gasket 961 is fixed on the shell 91. A control panel 95 of the drum washing machine 9 is arranged on an upper part of the front side of the shell 91 to facilitate the user's operation. An outer cylinder 92 and an inner cylinder 93 are arranged inside the shell 91. The inner cylinder 93 is positioned inside the outer cylinder 92. The inner cylinder 93 is connected to a motor 931 (e.g., a direct drive motor) through a transmission shaft 932 and a bearing 933. A water inflow valve 51 is provided on an upper part of a rear side of the shell 91, and the water inflow valve 51 is connected to a micro-bubble spray head 52 through a water pipe. As shown in FIG. 2, the micro-bubble spray head 52 is positioned close to the upper part of the front side of the shell 91 and located below the control panel 95. Similar to the above example, water enters the micro-bubble spray head 52 through the water pipe from the water inflow valve 51 to generate micro-bubble water containing a large number of micro-bubbles. The micro-bubble spray head 52 first sprays the micro-bubble water into a detergent box to mix with a detergent (or other clothing treatment agents), and then the micro-bubble water enters the inner cylinder 93 through the detergent box for clothing washing. Optionally, the micro-bubble spray head 52 can also directly spray the micro-bubble water carrying a large number of micro-bubbles into the outer cylinder 92 or the inner cylinder 93 of the washing machine to further reduce the amount of detergent used and enhance the cleaning ability of the washing machine.

Reference is made to FIGS. 3 to 6, which are schematic views of an example of the micro-bubble spray head according to the present disclosure, in which FIG. 3 is a schematic perspective view of the example of the micro-bubble spray head according to the present disclosure, FIG. 4 is a top view of the example of the micro-bubble spray head according to the present disclosure shown in FIG. 3, FIG. 5 is a left side view of the example of the micro-bubble spray head according to the present disclosure shown in FIG. 3, and FIG. 6 is a front view of the example of the micro-bubble spray head according to the present disclosure shown in FIG. 3. As shown in FIGS. 3 to 6, in one or more examples, the micro-bubble spray head 52 of the present disclosure includes a one-piece spray pipe 521. A micro-bubble bubbler 522 is fixed at an outlet end 212 of the one-piece spray pipe 521, and the micro-bubble bubbler 522 is configured to be capable of cutting and mixing the bubble water when the bubble water flow through the micro-bubble bubbler 522 to produce micro-bubble water containing a large number of micro-bubbles.

Referring to FIG. 3, in one or more examples, the one-piece spray pipe 521 has an inlet end 211 and the outlet end 212. The micro-bubble bubbler 522 is fixed on the outlet end 212, and the inlet end 211 is configured to be connected to an external water source. Optionally, an anti-disengagement part 213 may be provided on the inlet end 211, such as an anti-disengagement rib protruding radially outward around an outer wall of the inlet end 211 or an annular groove structure recessed inward from the outer wall of the inlet end 211. The anti-disengagement part can prevent the one-piece spray pipe 521 from falling off a connected pipeline which provides water supply.

With continued reference to FIG. 3, in one or more examples, the outer wall of the one-piece spray pipe 521 is provided with a first fixed installation part 214A, a second fixed installation part 214B, and a positioning part 215, which are used to position and fix the micro-bubble spray head 52 to a predetermined position.

With reference to FIGS. 4 to 6, the first fixed installation part 214A and the second fixed installation part 214B are symmetrically positioned on the outer wall of the one-piece spray pipe 521, and are located in the middle of the one-piece spray pipe 521. The positioning part 215 is a long-strip-shaped rib, which protrudes radially outward from the outer wall of the one-piece spray pipe 521 and extends in a longitudinal direction of the one-piece spray pipe 521. The first fixed installation part 214A and the second fixed installation part 214B are distributed on both sides of the positioning part 215. Optionally, only one fixed installation part is provided on the one-piece spray pipe 521, and the positioning part 215 may also be in other suitable forms.

In one or more examples, the first and second fixed installation parts 214A, 214B are screw hole structures so that the spray head 52 can be fixed to a target position by screws. However, the fixed installation parts may be any suitable connection structure in other forms, such as a snap-fit connection structure, a welded connection structure, and the like.

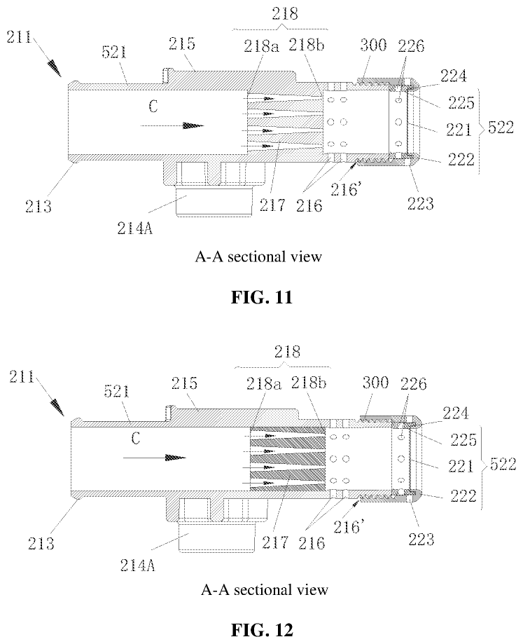

FIG. 11 is a cross-sectional view of an example of the micro-bubble spray head of the present disclosure in the third embodiment, taken along section line A-A in FIG. 6. As shown in FIG. 11, a diameter-decreased conical passage part 217 is arranged in the one-piece spray pipe 521 in the water flow direction C. In one or more examples, the diameter-decreased conical passage part 217 is integrally formed with the one-piece spray pipe 521, such as by integral injection molding. In an alternative example, the diameter-decreased conical passage part 217 is formed independently from the one-piece spray pipe 521, and is then inserted into the one-piece spray pipe 521 and snap-fitted in the one-piece spray pipe 521. Alternatively, the independently formed diameter-decreased conical passage part 217 can also be press-fitted into the one-piece spray pipe 521.

With reference to FIG. 11, a plurality of diameter-decreased conical passages 218 parallel to each other are provided in the diameter-decreased conical passage part 217. In one or more examples, the number of diameter-decreased conical passages 218 is two (2) to sixteen (16), and these diameter-decreased conical passages are evenly distributed in an annular form around a centerline of the one-piece spray pipe 521. Alternatively, the number of diameter-decreased conical passages 218 may be six (6) to nine (9). Optionally, these diameter-decreased conical passages may also be arranged in other forms than annular and may not be evenly distributed. In one or more examples, all the diameter-decreased conical passages 218 are the same as each other. Alternatively, these diameter-decreased conical passages 218 may also have different arrangements; for example, at the same radial position, the cross section of the diameter-decreased conical passage near the center of the one-piece spray pipe 521 is larger than the cross section of the diameter-decreased conical passage away from the center of the one-piece spray pipe 521.

With continued reference to FIG. 11, each of the diameter-decreased conical passages 218 includes an inlet 218a and an outlet 218b. A water flow flowing from the inlet end 211 of the one-piece spray pipe 521 enters the corresponding passage from the inlet 218a of each diameter-decreased conical passage 218 and is thus divided into multiple streams of water flows. The multiple streams of water flows are pressurized in the corresponding diameter-decreased conical passages 218 due to a gradual reduction of the cross section of the flow passage, and are rapidly expanded when the multiple streams of water flows are sprayed from the outlets 218b of the plurality of diameter-decreased conical passages 218, thereby generating a negative pressure region near the outlets 218b of the plurality of diameter-decreased conical passages 218.

As shown in FIG. 11, a plurality of air inflow holes 216 serving as the air inflow passage are formed on the outer wall of the one-piece spray pipe 521. These air inflow holes 216 are arranged into two rings around the outer wall of the one-piece spray pipe 521, and these air inflow holes 216 are positioned close to the outlets 218b of the diameter-decreased conical passages 218, so they are in the negative pressure region. Under the action of the negative pressure, a large amount of outside air can be sucked into the one-piece spray pipe 521 from the air inflow holes 216 and mix with the multiple streams of water flows sprayed from the plurality of diameter-decreased conical passages 218 to generate bubble water. The bubble water then flows to the downstream micro-bubble bubbler 522 to form micro-bubble water. In an alternative example, more or fewer air inflow holes may be provided as needed, and they may be arranged in other forms, such as in a staggered arrangement.

The micro-bubble bubbler 522 at the outlet end 212 of the one-piece spray pipe 521 includes a hole mesh 221 and a hole mesh skeleton 222. The hole mesh 221 is attached to the outlet end 212 of the one-piece spray pipe 521 through the hole mesh skeleton 222.

In one or more examples, the hole mesh 221 has at least one fine hole having a diameter reaching a micron scale. Preferably, the diameter of the fine hole is between 0 and 1000 microns; more preferably, the diameter of the fine hole is between 5 microns and 500 microns. The hole mesh 221 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the hole mesh 221 may be other hole mesh structures capable of generating micro-bubbles, such as a hole mesh structure composed of two non-micron-scale honeycomb structures. When the bubble water flows through the hole mesh 221, the hole mesh 221 mixes and cuts the bubble water, thereby generating micro-bubble water.

Referring to FIG. 11, the hole mesh skeleton 222 is cylindrical so that it can be sleeved over the outlet end 212 of the one-piece spray pipe 521. In one or more examples, the hole mesh skeleton 222 and the outlet end 212 of the one-piece spray pipe are fixed together by a threaded connection part 300. For example, internal threads are formed on an inner wall of the hole mesh skeleton 222, and external threads are formed on an outer wall of the outlet end 212, in which the internal threads and the external threads are meshed together. In an alternative example, the hole mesh skeleton 222 may take other suitable forms, such as a pressing plate, and it can connected to the outlet end of the one-piece spray pipe 521 through other connection means, such as welding. Optionally, the hole mesh can also be formed directly on the outlet end 212 of the one-piece spray pipe.

In one or more examples, an air inflow passage may also be formed between the connection parts of the hole mesh skeleton 222 and the outlet end 212 of the one-piece spray pipe; for example, a set gap reserved between the internal threads and the external threads that mesh with each other can serve as a threaded air inflow passage 216′. The air inflow passage can be used alone as the air inflow passage of the micro-bubble spray head of the present disclosure, or it can also be used in combination with the air inflow holes 216.

As shown in FIGS. 3-6 and 11, in one or more examples, the hole mesh skeleton 222 is provided with a plurality of overflow holes 223 along its periphery, and these overflow holes are positioned close to the hole mesh 221. When the bubble water cannot pass through the hole mesh 221 in time, the excess bubble water can flow out from the overflow holes 223, thereby preventing the excess water from flowing back and flooding the air inflow holes 216. Therefore, the overflow holes 223 can prevent a situation in which the air cannot be sucked into the one-piece spray pipe due to the blockage of the air inflow holes 216 so that the micro-bubble water cannot be generated. In alternative examples, more or fewer overflow holes 223 may be provided as needed.

With continued reference to FIG. 11, in one or more examples, a pressure ring 225 is also provided between the hole mesh skeleton 222 and the outlet end 212 of the one-piece spray pipe 521. Correspondingly, a connection part 224 is provided on the periphery of the hole mesh 221. The pressure ring 225 presses the connection part 224 on the inner wall of the end of the hole mesh skeleton 222, so that the hole mesh 221 can be firmly fixed, and that the hole mesh 221 will not fall off the outlet end 212 of the one-piece spray pipe 521 when it is impacted by high-pressure water flow. In an alternative example, the hole mesh 221 can also be fixed by using other structures; for example, the hole mesh is clamped by a circlip. In one or more examples, the pressure ring 225 is also provided with a plurality of pressure ring holes 226. When a flow rate of sprayed water flow is not large, these pressure ring holes 226 can be used to suck in air so that the air mixes with the water flow. When the flow rate of sprayed water flow is relatively large, these pressure ring holes 226 allow some water to overflow from them, which can not only help clean the hole mesh, but also can prevent excess water from flowing backward through the air inflow passage to cause the inability to suck in air through the air inflow passage.

FIG. 12 is a cross-sectional view of another example of the micro-bubble spray head of the present disclosure in the third embodiment, taken along section line A-A in FIG. 6. As shown in FIG. 12, in this embodiment, the diameter-decreased conical passage part 217 is formed independently from the one-piece spray pipe 521 by injection molding. In addition, in this embodiment, the hole mesh skeleton 222 and the outlet end 212 of the one-piece spray pipe are also fixed together by the threaded connection part 300, and a threaded air inflow passage 216′ is formed in the threaded connection part 300; for example, the threaded air inflow passage 216′ is a gap formed between external threads and internal threads. Therefore, in this embodiment, the air inflow passage not only includes the air inflow holes 216 on the outer wall of the one-piece spray pipe 521, but also includes the threaded air inflow passage 216′. In an alternative embodiment, the air inflow passage of the spray head 52 may also only include an air inflow passage provided between the outlet end of the one-piece spray pipe 521 and the micro-bubble bubbler.

Hitherto, the technical solutions of the present disclosure have been described in connection with the preferred embodiments shown in the accompanying drawings, but it is easily understood by those skilled in the art that the scope of protection of the present disclosure is obviously not limited to these specific embodiments. Without departing from the principles of the present disclosure, those skilled in the art can combine technical features from different embodiments, and can also make equivalent changes or replacements to relevant technical features. All these technical solutions after such changes or replacements will fall within the scope of protection of the present disclosure.

1-30. (canceled)

31. A micro-bubble spray head, comprising a one-piece spray pipe and a micro-bubble bubbler fixed at an outlet end of the one-piece spray pipe, wherein:
a throttling passage part is provided in the one-piece spray pipe, and the throttling passage part is formed therein with a plurality of throttling passages parallel to each other in a water flow direction, so that multiple streams of water flows can be formed in the plurality of throttling passages and sprayed in an expanded state from outlets of the plurality of throttling passages to generate a negative pressure near the outlets; and
an air inflow passage is also provided on the one-piece spray pipe, and the air inflow passage is positioned close to the outlets so that air can be sucked in from the air inflow passage under the action of the negative pressure and mix with the multiple streams of water flows to generate bubble water, which becomes micro-bubble water under the action of the micro-bubble bubbler.

32. The micro-bubble spray head according to claim 31, wherein each of the plurality of throttling passages is an equal-section throttling passage.

33. The micro-bubble spray head according to claim 31, wherein the throttling passage part is a varying-diameter passage part, and each of the plurality of throttling passages is a varying-diameter passage; each of the varying-diameter passages comprises a diameter-decreased conical passage and a diameter-increased conical passage in sequence in the water flow direction, and a water flow that can be pressurized by the diameter-decreased conical passage can be expanded in the diameter-increased conical passage to generate a negative pressure near an outlet of the varying-diameter passage.

34. The micro-bubble spray head according to claim 31, wherein the throttling passage part is a diameter-decreased conical passage part, and each of the plurality of throttling passages is a diameter-decreased conical passage.

35. The micro-bubble spray head according to claim 31, wherein the throttling passage part is integrally formed with the one-piece spray pipe.

36. The micro-bubble spray head according to claim 31, wherein the throttling passage part is formed independently from the one-piece spray pipe.

37. The micro-bubble spray head according to claim 31, wherein the plurality of throttling passages are evenly distributed in an annular form around a center of the one-piece spray pipe.

38. The micro-bubble spray head according to claim 31, wherein the air inflow passage is a plurality of air inflow holes arranged on a pipe wall of the one-piece spray pipe, or the air inflow passage is formed between the outlet end and the micro-bubble bubbler.

39. The micro-bubble spray head according to claim 31, wherein the micro-bubble bubbler comprises a hole mesh and a hole mesh skeleton, and the hole mesh is attached to the outlet end of the one-piece spray pipe through the hole mesh skeleton.

40. The micro-bubble spray head according to claim 39, wherein the hole mesh skeleton is provided with at least one overflow hole, and the at least one overflow hole is positioned close to the hole mesh.

41. The micro-bubble spray head according to claim 39, wherein the micro-bubble bubbler also comprises a pressure ring, and the pressure ring is configured to be positioned between the hole mesh skeleton and the outlet end of the one-piece spray pipe to fix the hole mesh.

42. The micro-bubble spray head according to claim 41, wherein a plurality of pressure ring holes are provided on the pressure ring in a circumferential direction.

43. A washing apparatus, comprising the micro-bubble spray head according to claim 31, wherein the micro-bubble spray head is configured to generate micro-bubble water in the washing apparatus.
